(19) United States
(12) Patent Application Publication
(10) Pub. No.: US 2024/0183287 A1
(43) Pub. Date: Jun. 6, 2024

(54) TURBOMACHINE

(71) Applicant: Kabushiki Kaisha Toyota Jidoshokki, Kariya-shi, Aichi (JP)

(72) Inventors: Fumihiro SUZUKI, Kariya-shi, Aichi (JP); Fumiya Shinoda, Kariya-shi, Aichi (JP)

(73) Assignee: Kabushiki Kaisha Toyota Jidoshokki, Kariya-shi, Aichi (JP)

(21) Appl. No.: 18/365,463

(22) Filed: Aug. 4, 2023

(30) Foreign Application Priority Data
Dec. 6, 2022 (JP) 2022-194730

(51) Int. Cl. F01D 25/16

(52) U.S. Cl. CPC F01D 25/16; F05D 2240/52

(57) ABSTRACT

A turbomachine includes a rotary shaft, an impeller, a thrust collar, and a first fluid dynamic thrust bearing and a second fluid dynamic thrust bearing that are arranged in an axial direction of the rotary shaft with the thrust collar interposed therebetween. The thrust collar has a first surface and a second surface. When the thrust collar is rotated, a dynamic pressure generated between the first fluid dynamic thrust bearing and the first surface is larger than that generated between the second fluid dynamic thrust bearing and the second surface. The thrust collar is formed of the first surface and the second surface, which have different shapes or materials in order to reduce warpage deformation of the first surface when the thrust collar is rotated.

### CROSS-REFERENCE TO RELATED APPLICATION

This application claims priority to Japanese Patent Application No. 2022-194730 filed on Dec. 6, 2022, the entire disclosure of which is incorporated herein by reference.

### BACKGROUND ART

The present disclosure relates to a turbomachine.

A turbomachine includes a rotary shaft, an impeller, a thrust collar, a first fluid dynamic thrust bearing, and a second fluid dynamic thrust bearing. The impeller is integrally rotated with the rotary shaft. The thrust collar is formed in a disk-shape. The thrust collar protrudes outward in a radial direction of the rotary shaft from an outer peripheral surface of the rotary shaft. The thrust collar is integrally rotated with the rotary shaft. As is disclosed in International Patent Application Publication No. WO2020/149137, the first fluid dynamic thrust bearing and the second fluid dynamic thrust bearing are arranged in an axial direction of the rotary shaft with the thrust collar interposed between the first fluid dynamic thrust bearing and the second fluid dynamic thrust bearing. The thrust collar has a first surface facing the first fluid dynamic thrust bearing and a second surface facing the second fluid dynamic thrust bearing.

When the thrust collar is rotated, a dynamic pressure generated between the first fluid dynamic thrust bearing and the first surface of the thrust collar may be larger than that generated between the second fluid dynamic thrust bearing and the second surface of the thrust collar, for example. Here, a temperature of the first surface becomes higher than that of the second surface. This causes a difference in thermal expansion between the first surface and the second surface. The generated difference in thermal expansion may cause warpage deformation of the first surface. The warpage deformation of the first surface in the thrust collar increases a thickness of air film between the first fluid dynamic thrust bearing and the first surface of the thrust collar. As the thickness of the air film between the first fluid dynamic thrust bearing and the first surface of the thrust collar increases, the dynamic pressure generated therebetween decreases, which decreases a load capacity of the first fluid dynamic thrust bearing. This makes it difficult to stably support the rotary shaft through the thrust collar in a thrust direction of the rotary shaft by the first fluid dynamic thrust bearing and the second fluid dynamic thrust bearing.

### SUMMARY

In accordance with an aspect of the present disclosure, there is provided a turbomachine including a rotary shaft, an impeller that is integrally rotated with the rotary shaft, a thrust collar that is formed in a disk-shape protruding outward in a radial direction of the rotary shaft from an outer peripheral surface of the rotary shaft, the thrust collar being integrally rotated with the rotary shaft, and a first fluid dynamic thrust bearing and a second fluid dynamic thrust bearing that are arranged in an axial direction of the rotary shaft with the thrust collar interposed between the first fluid dynamic thrust bearing and the second fluid dynamic thrust bearing. The thrust collar has a first surface facing the first fluid dynamic thrust bearing and a second surface facing the second fluid dynamic thrust bearing. When the thrust collar is rotated, a dynamic pressure generated between the first fluid dynamic thrust bearing and the first surface is larger than a dynamic pressure generated between the second fluid dynamic thrust bearing and the second surface. The thrust collar is formed of the first surface and the second surface, which have different shapes or materials in order to reduce warpage deformation of the first surface when the thrust collar is rotated.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a configuration view schematically illustrating a turbomachine in an embodiment;

FIG. 2 is a cross-sectional view illustrating a relation between a first fluid dynamic thrust bearing and a second fluid dynamic thrust bearing in the embodiment;

FIG. 3 is a cross-sectional view illustrating a relation between a first fluid dynamic thrust bearing and a second fluid dynamic thrust bearing in a first modified example; and

FIG. 4 is a cross-sectional view illustrating a relation between a first fluid dynamic thrust bearing and a second fluid dynamic thrust bearing in a second modified example.

### DETAILED DESCRIPTION OF THE EMBODIMENTS

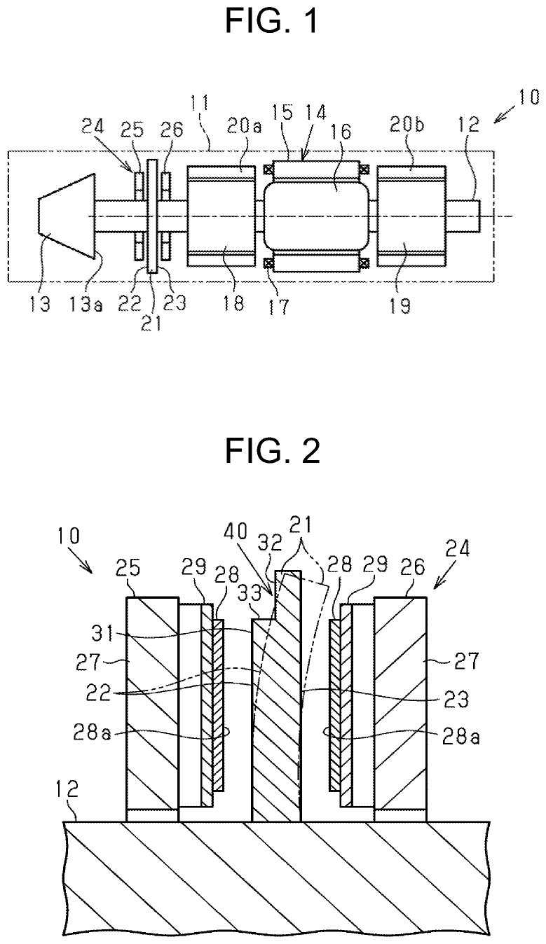

The following will describe an embodiment of a turbomachine with reference to FIGS. 1 and 2. The turbomachine in the present embodiment is mounted on a fuel cell vehicle. The fuel cell vehicle includes a fuel cell system that generates electricity by supplying oxygen and hydrogen to a fuel cell for vehicles. The turbomachine is configured to compress air including oxygen, which is supplied to the fuel cell for vehicles.

### <Basic Configuration of Turbomachine 10>

As illustrated in FIG. 1, a turbomachine 10 includes a housing 11 formed in a cylindrical shape. The turbomachine 10 includes a rotary shaft 12 and an impeller 13. The rotary shaft 12 and the impeller 13 are accommodated in the housing 11. The rotary shaft 12 is disposed coaxially with the housing 11 therein. The impeller 13 is connected to a first end of the rotary shaft 12. The impeller 13 is integrally rotated with the rotary shaft 12. As the impeller 13 extends from a rear surface 13a to an end, a diameter of the impeller 13 gradually decreases. The impeller 13 is rotated to compress the air, which is supplied to the fuel cell for vehicles.

The turbomachine 10 includes a motor 14. The motor 14 has a stator 15 and a rotor 16. The stator 15 is formed in a cylindrical shape. The stator 15 is fixed to an inner peripheral surface of the housing 11. The rotor 16 is disposed inside the stator 15. The rotor 16 is fixed to the rotary shaft 12. The rotor 16 integrally rotates with the rotary shaft 12. The stator 15 has a coil 17. When an electric current flows from a battery, which is not illustrated, to a coil 17, the rotor 16 integrally rotates with the rotary shaft 12. As a result, the impeller 13 is integrally rotated with the rotary shaft 12.

The rotary shaft 12 has a first supporting portion 18 and a second supporting portion 19. The first supporting portion 18 is located between the impeller 13 and the motor 14 in the rotary shaft 12. The motor 14 is located between the impeller 13 and the second supporting portion 19 in the rotary shaft 12.

The turbomachine 10 includes a first radial bearing 20a and a second radial bearing 20b. The first radial bearing 20a rotatably supports the first supporting portion 18 in a radial direction. The second radial bearing 20b rotatably supports the second supporting portion 19 in the radial direction. Here, the “radial direction” is a direction orthogonal to an axial direction of the rotary shaft 12. Accordingly, the “radial direction” corresponds to a radial direction of the rotary shaft 12. In a subsequent description, the axial direction of the rotary shaft 12 may be referred to as a “thrust direction”.

The turbomachine 10 includes a thrust collar 21. The thrust collar 21 is formed in a disk-shape. The thrust collar 21 protrudes outward in the radial direction of the rotary shaft 12 from an outer peripheral surface of the rotary shaft 12. Specifically, the thrust collar 21 protrudes outward in the radial direction of the rotary shaft 12 from a portion between the impeller 13 and the first supporting portion 18 in the outer peripheral surface of the rotary shaft 12. A thickness direction of the thrust collar 21 coincides with the axial direction of the rotary shaft 12. Accordingly, the thickness direction of the thrust collar 21 coincides with the thrust direction. A radial direction of the thrust collar 21 coincides with the radial direction of the rotary shaft 12. The thrust collar 21 is integrally rotated with the rotary shaft 12.

The thrust collar 21 has a first surface 22 and a second surface 23. The first surface 22 of the thrust collar 21 is located on one side in the thrust direction. The second surface 23 of the thrust collar 21 is located on the other side in the thrust direction. The thrust collar 21 is provided on the rotary shaft 12 such that the first surface 22 is located near the impeller 13 and the second surface 23 is located near the first supporting portion 18.

The turbomachine 10 includes a fluid dynamic thrust bearing 24. The fluid dynamic thrust bearing 24 includes a first fluid dynamic thrust bearing 25 and a second fluid dynamic thrust bearing 26. Accordingly, the turbomachine 10 includes the first fluid dynamic thrust bearing 25 and the second fluid dynamic thrust bearing 26. The first fluid dynamic thrust bearing 25 is disposed between the thrust collar 21 and the impeller 13 in the axial direction of the rotary shaft 12. The first fluid dynamic thrust bearing 25 supports the first surface 22 of the thrust collar 21. That is, the first surface 22 faces the first fluid dynamic thrust bearing 25. The second fluid dynamic thrust bearing 26 is disposed between the thrust collar 21 and the first supporting portion 18 in the axial direction of the rotary shaft 12. The second fluid dynamic thrust bearing 26 supports the second surface 23 of the thrust collar 21. That is, the second surface 23 faces the second fluid dynamic thrust bearing 26. The first fluid dynamic thrust bearing 25 and the second fluid dynamic thrust bearing 26 are arranged in the axial direction of the rotary shaft 12 with the thrust collar 21 interposed therebetween. The first fluid dynamic thrust bearing 25 and the second fluid dynamic thrust bearing 26 support the rotary shaft 12 through the thrust collar 21 in the thrust direction.

As illustrated in FIG. 2, the first fluid dynamic thrust bearing 25 and the second fluid dynamic thrust bearing 26 each have a bearing housing 27, a top foil 28, and a bump foil 29. The first fluid dynamic thrust bearing 25 has the same configuration as that of the second fluid dynamic thrust bearing 26.

The bearing housing 27 is fixed to the housing 11. The top foil 28 is disposed between the bearing housing 27 and the thrust collar 21. The top foil 28 has a facing surface 28a facing the thrust collar 21 in the thrust direction. The bump foil 29 is disposed between the bearing housing 27 and the top foil 28. The bump foil 29 is supported by the bearing housing 27. The bump foil 29 is disposed between the bearing housing 27 and the top foil 28 and elastically supports the top foil 28. The bump foil 29 is formed in a waved thin plate shape in which crests and troughs alternate with each other in a circumferential direction of the rotary shaft 12. The top foil 28 of the fluid dynamic thrust bearing 24 is formed such that a plurality of top foil pieces, which are each formed in a fan shape, are arranged in the circumferential direction of the rotary shaft 12. These first fluid dynamic thrust bearing 25 and second fluid dynamic thrust bearing 26 have been already known.

### <Thrust Collar 21>

The first surface 22 of the thrust collar 21 has a first stepped surface 31 and a second stepped surface 32. The first stepped surface 31 and the second stepped surface 32 extend in a radial direction of the thrust collar 21. The first stepped surface 31 is parallel with the second stepped surface 32. The first stepped surface 31 and the second stepped surface 32 are each formed in a ring shape. The first stepped surface 31 is located inside the second stepped surface 32 in the radial direction of the thrust collar 21. The first stepped surface 31 is closer to the first fluid dynamic thrust bearing 25 than the second stepped surface 32. The first stepped surface 31 is connected to the second stepped surface 32 through a connecting surface 33 formed in a ring shape and extending along a thickness direction of the thrust collar 21. The first surface 22 is formed in a stepped shape that is stepped in tiers farther from the first fluid dynamic thrust bearing 25 as the first surface 22 extends outward in the radial direction of the thrust collar 21. That is, the first surface 22 is formed in the stepped shape that is stepped in tiers farther from the first fluid dynamic thrust bearing 25 as the first surface 22 extends outward in the radial direction of the rotary shaft 12.

The first stepped surface 31 extends outward in the radial direction of the rotary shaft 12 from the outer peripheral surface of the rotary shaft 12, and an outer peripheral edge of the first stepped surface 31 faces an outer peripheral edge of the top foil 28 of the first fluid dynamic thrust bearing 25 in the thrust direction. Accordingly, the first stepped surface 31 faces a whole surface of the facing surface 28a of the top foil 28 in the thrust direction. The second stepped surface 32 does not face the facing surface 28a of the top foil 28 in the thrust direction. The second surface 23 is formed in a flat surface shape. An outer peripheral surface of the thrust collar 21 connects an outer peripheral edge of the second surface 23 to an outer peripheral edge of the second stepped surface 32 of the first surface 22.

The second stepped surface 32 and the connecting surface 33 forms a recess 40 that is recessed from the first stepped surface 31 toward the second surface 23. Thus, the recess 40 is formed in an outer peripheral portion of the thrust collar 21 in the radial direction of the rotary shaft 12 and recessed from the first surface 22 toward the second surface 23, which results in a difference in shape between the first surface 22 and the second surface 23. Accordingly, the thrust collar 21 is formed of the first surface 22 and the second surface 23, which have different shapes. The recess 40 is continuous with the outer peripheral surface of the thrust collar 21.

### Operation in the Embodiment

The following will describe an operation of the present embodiment.

When the turbomachine 10 is driven, a pressure of air is applied to the rear surface 13a of the impeller 13. Then, a thrust load is applied to the rotary shaft 12 in accordance with a rotation of the impeller 13. The thrust load is applied to the rotary shaft 12 in a direction toward the impeller 13 in the thrust direction. As a result, the thrust collar 21 moves toward the first fluid dynamic thrust bearing 25 integrally with the rotary shaft 12 when the turbomachine 10 is driven.

The first fluid dynamic thrust bearing 25 supports the thrust collar 21 in contact with the thrust collar 21 until a rotational speed of the rotary shaft 12 reaches a floating rotational speed at which the thrust collar 21 floats up from the first fluid dynamic thrust bearing 25. When the rotational speed of the rotary shaft 12 reaches the floating rotational speed, a dynamic pressure generated between the thrust collar 21 and the first fluid dynamic thrust bearing 25 causes the thrust collar 21 to float on the pressurized air away from the first fluid dynamic thrust bearing 25. Thus, the first fluid dynamic thrust bearing 25 supports the thrust collar 21 in a contactless manner. In addition, a dynamic pressure of air generated between the thrust collar 21 and the second fluid dynamic thrust bearing 26 causes the thrust collar 21 to float on the pressurized air away from the second fluid dynamic thrust bearing 26. Thus, the fluid dynamic thrust bearing 24 supports the thrust collar 21 in a contactless manner.

A direction of the thrust load that is applied to the rotary shaft 12 corresponds to the direction toward the impeller 13 in the thrust direction. For this reason, when the thrust collar 21 is rotated, the dynamic pressure generated between the first fluid dynamic thrust bearing 25 and the first surface 22 of the thrust collar 21 is larger than that generated between the second fluid dynamic thrust bearing 26 and the second surface 23 of the thrust collar 21. Then, a temperature of the first surface 22 becomes higher than that of the second surface 23. This causes a difference in thermal expansion between the first surface 22 and the second surface 23. Here, as illustrated by an imaginary line in FIG. 2, a case where the first surface 22 has a flat surface shape is assumed. In this case, a difference in thermal expansion between the first surface 22 and the second surface 23 may cause warpage deformation of the first surface 22 in the thrust collar 21.

In the present embodiment, the recess 40 is formed in the outer peripheral portion of the thrust collar 21 in the radial direction of the rotary shaft 12 and recessed from the first surface 22 toward the second surface 23, so that the thrust collar 21 is formed of the first surface 22 and the second surface 23, which have different shapes. This configuration suppresses an increase in temperature of the whole of the first surface 22 by a space between a portion of the thrust collar 21 having the recess 40 and the first fluid dynamic thrust bearing 25, for example, as compared to the case where the first surface 22 of the thrust collar 21 has the flat surface shape. As a result, the thermal expansion of the first surface 22 is suppressed. This reduces an amount of deformation caused by the difference in thermal expansion between the first surface 22 and the second surface 23 in the thrust collar 21. That is, the warpage deformation of the first surface 22 in the thrust collar 21 is suppressed. As described above, the thrust collar 21 is formed of the first surface 22 and the second surface 23, which have different shapes in order to reduce the warpage deformation of the first surface 22 when the thrust collar 21 is rotated.

### Advantageous Effects in the Embodiment

The following advantageous effects are obtained in the above-described embodiment.

(1) When the thrust collar 21 is rotated, for example, the dynamic pressure generated between the first fluid dynamic thrust bearing 25 and the first surface 22 is assumed to be larger than that generated between the second fluid dynamic thrust bearing 26 and the second surface 23. The thrust collar 21 is formed of the first surface 22 and the second surface 23, which have the different shapes in order to reduce the warpage deformation of the first surface 22 when the thrust collar 21 is rotated. This reduces the amount of deformation caused by the difference in thermal expansion between the first surface 22 and the second surface 23 in the thrust collar 21. That is, the warpage deformation of the first surface 22 in the thrust collar 21 is suppressed. Accordingly, it is suppressed that a load capacity of the first fluid dynamic thrust bearing 25 decreases, so that the first fluid dynamic thrust bearing 25 and the second fluid dynamic thrust bearing 26 stably support the rotary shaft 12 through the thrust collar 21.

(2) The recess 40 is formed in the outer peripheral portion of the thrust collar 21 in the radial direction of the rotary shaft 12 and recessed from the first surface 22 toward the second surface 23, which results in the difference in shape between the first surface 22 and the second surface 23. This configuration suppresses an increase in temperature of the whole of the first surface 22 by the space between the portion of the thrust collar 21 having the recess 40 and the first fluid dynamic thrust bearing 25, for example, as compared to the case where the first surface 22 of the thrust collar 21 has the flat surface shape. As a result, the thermal expansion of the first surface 22 is suppressed. This reduces the amount of deformation caused by the difference in thermal expansion between the first surface 22 and the second surface 23 in the thrust collar 21.

### MODIFIED EXAMPLES

The embodiment may be modified as described below. The above-described embodiment and the following modified example may be combined with each other as long as they does not technically contradict each other.

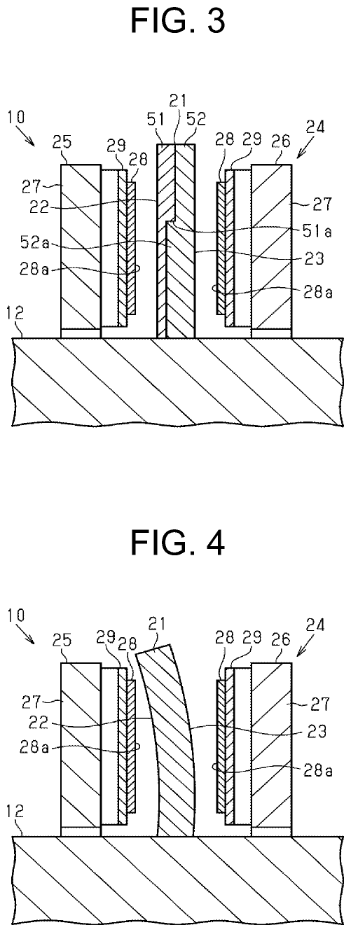

In a first modified example illustrated in FIG. 3, the thrust collar 21 includes a first collar member 51 having the first surface 22 and a second collar member 52 having the second surface 23 and connected to the first collar member 51. The first collar member 51 and the second collar member 52 each have a plate shape. The first collar member 51 and the second collar member 52 are fixed to each other with their thickness directions coinciding with each other. An engaged recess 51a is formed in the first collar member 51 and recessed from a surface adjacent to the second collar member 52. An engaging protrusion 52a is formed in the second collar member 52 and protrudes from a surface adjacent to the first collar member 51. The first collar member 51 and the second collar member 52 are connected to each other by engaging the engaging protrusion 52a into the engaged recess 51a.

A surface of the first collar member 51 opposite to the surface adjacent to the second collar member 52 corresponds to the first surface 22. The first surface 22 is formed in a flat surface shape. A surface of the second collar member 52 opposite to the surface adjacent to the first collar member 51 corresponds to the second surface 23. The second surface 23 is formed in a flat surface shape.

A coefficient of linear thermal expansion of a material of the first collar member 51 is smaller than that of a material of the second collar member 52. The first collar member 51 is, for example, made of a stainless steel. The second collar member 52 is, for example, made of iron. The material of the first collar member 51 is not particularly limited as long as the material of the first collar member 51 has a smaller coefficient of linear thermal expansion than that of the material of the second collar member 52. Accordingly, the thrust collar 21 is formed of the first surface 22 and the second surface 23, which have different materials.

Since the coefficient of linear thermal expansion of the material of the first collar member 51 is smaller than that of the material of the second collar member 52, thermal expansion of the first surface 22 is suppressed, for example, as compared to a case where the coefficient of linear thermal expansion of the material of the first collar member 51 is the same as that of the material of the second collar member 52. For this reason, an amount of deformation caused by the difference in thermal expansion between the first surface 22 and the second surface 23 in the thrust collar 21 are reduced. As described above, the thrust collar 21 is formed of the first surface 22 and the second surface 23, which have different materials in order to reduce the warpage deformation of the first surface 22 when the thrust collar 21 is rotated.

The first collar member 51 and the second collar member 52 may be connected to each other with a fastener such as a bolt other than the engaging of the engaging protrusion 52a into the engaged recess 51a. The first collar member 51 and the second collar member 52 may be connected by adhering, welding, or the like.

In a second modified example illustrated in FIG. 4, the first surface 22 is a curved surface that gradually approaches the first fluid dynamic thrust bearing 25 and is gradually spaced from the second fluid dynamic thrust bearing 26 as the first surface 22 extends outward in the radial direction of the rotary shaft 12 from the outer peripheral surface of the rotary shaft 12. In addition, the second surface 23 is a curved surface that gradually approaches the first fluid dynamic thrust bearing 25 and is gradually spaced from the second fluid dynamic thrust bearing 26 as the second surface 23 extends outward in the radial direction of the rotary shaft 12 from the outer peripheral surface of the rotary shaft 12. An outer peripheral surface of the thrust collar 21 connects an outer peripheral edge of the first surface 22 to an outer peripheral edge of the second surface 23. A perimeter of the first surface 22 is shorter than that of the second surface 23.

This configuration further suppresses an increase in temperature of the portion of the first surface 22 spaced farther from the first fluid dynamic thrust bearing 25 in a whole of the first surface 22 and decreases an area of the first surface 22 in which thermal expansion occurs, for example, as compared to a case where the first surface 22 is formed in a flat surface shape extending in the radial direction of the rotary shaft 12 and a perimeter of the first surface 22 is the same as that of the second surface 23. As a result, the thermal expansion of the first surface 22 is suppressed. This reduces an amount of deformation caused by the difference in thermal expansion between the first surface 22 and the second surface 23 in the thrust collar 21. As described above, the thrust collar 21 is formed of the first surface 22 and the second surface 23, which have different shapes in order to reduce the warpage deformation of the first surface 22 when the thrust collar 21 is rotated.

In the embodiment, as the first surface 22 extends outward in the radial direction of the rotary shaft 12, the first surface 22 may be formed so as to be partly spaced from the first fluid dynamic thrust bearing 25 and approach the second surface 23. That is, the first surface 22 may be an inclined surface that is inclined relative to the second surface 23. In this case, the inclined surface forms a recess that is formed in the outer peripheral portion in the radial direction of the rotary shaft 12 and recessed toward the second surface 23. The first surface 22 includes the inclined surface forming a recess that is formed in the outer peripheral portion in the radial direction of the rotary shaft 12 and recessed toward the second surface 23, which may result in the difference in shape between the first surface 22 and the second surface 23. This configuration suppresses an increase in temperature of a portion of the first surface 22 spaced farther from the first fluid dynamic thrust bearing 25 in a whole of the first surface 22 and an area of the first surface 22 in which thermal expansion occurs is decreased, for example, as compared to a case where the first surface 22 is formed in a flat surface shape extending in the radial direction of the rotary shaft 12 and a perimeter of the first surface 22 is the same as that of the second surface 23. As a result, the thermal expansion of the first surface 22 is suppressed.

In the embodiment, the recess 40 need not be continuous with the outer peripheral surface of the thrust collar 21.

In the embodiment, the impeller 13 may be provided on each end of the rotary shaft 12. In the turbomachine 10, air compressed by one of the impellers 13 may be compressed again by the other of the impellers 13.

In the embodiment, the turbomachine 10 may be applied in any suitable device and compress any suitable fluid. For example, the turbomachine 10 may be applied in an air conditioner and compress refrigerant as the fluid to be compressed. In addition, the turbomachine 10 may be mounted on any suitable object other than vehicles.

In the embodiment, the turbomachine 10 may be an expander in which a turbine wheel corresponding to an impeller is coupled to the rotary shaft 12.

What is claimed is:

1. A turbomachine comprising:
a rotary shaft;
an impeller that is integrally rotated with the rotary shaft;
a thrust collar that is formed in a disk-shape protruding outward in a radial direction of the rotary shaft from an outer peripheral surface of the rotary shaft, the thrust collar being integrally rotated with the rotary shaft; and
a first fluid dynamic thrust bearing and a second fluid dynamic thrust bearing that are arranged in an axial direction of the rotary shaft with the thrust collar interposed between the first fluid dynamic thrust bearing and the second fluid dynamic thrust bearing, and
the thrust collar having a first surface facing the first fluid dynamic thrust bearing and a second surface facing the second fluid dynamic thrust bearing, wherein
when the thrust collar is rotated, a dynamic pressure generated between the first fluid dynamic thrust bearing and the first surface is larger than a dynamic pressure generated between the second fluid dynamic thrust bearing and the second surface, and
the thrust collar is formed of the first surface and the second surface, which have different shapes or materials in order to reduce warpage deformation of the first surface when the thrust collar is rotated.

2. The turbomachine according to claim 1, wherein
the thrust collar is formed of the first surface and the second surface, which have the different shapes in order to reduce the warpage deformation of the first surface when the thrust collar is rotated, and
a recess is formed in an outer peripheral portion of the thrust collar in the radial direction of the rotary shaft and recessed from the first surface toward the second surface, which results in the difference in shape between the first surface and the second surface.

3. The turbomachine according to claim 1, wherein
the thrust collar is formed of the first surface and the second surface, which have the different materials in order to reduce the warpage deformation of the first surface when the thrust collar is rotated,
the thrust collar includes:
a first collar member forming the first surface; and
a second collar member forming the second surface and connected to the first collar member, and
a coefficient of linear thermal expansion of a material of the first collar member is smaller than a coefficient of linear thermal expansion of a material of the second collar member, which results in the difference in material between the first surface and the second surface.

4. The turbomachine according to claim 1, wherein
the thrust collar is formed of the first surface and the second surface, which have the different shapes in order to reduce the warpage deformation of the first surface when the thrust collar is rotated,
the first surface is a curved surface that gradually approaches the first fluid dynamic thrust bearing and is gradually spaced from the second fluid dynamic thrust bearing as the first surface extends outward in the radial direction of the rotary shaft,
the second surface is a curved surface that gradually approaches the first fluid dynamic thrust bearing and is gradually spaced from the second fluid dynamic thrust bearing as the second surface extends outward in the radial direction of the rotary shaft, and
a perimeter of the first surface is shorter than a perimeter of the second surface, which results in the difference in shape between the first surface and the second surface.
